(19) United States
(12) Patent Application Publication
(10) Pub. No.: US 2004/0252525 A1
(43) Pub. Date: Dec. 16, 2004

(54) Method and apparatus for disconnecting an electrical generator from the electricity supply

(76) Inventors: Kenneth Wayne Aldridge, Nottingham (GB); Kevin Ernest Woods, West Bridgford (GB)

Correspondence Address: NEEDLE & ROSENBERG, P.C., SUITE 1000, 999 PEACHTREE STREET, ATLANTA, GA, 30309-3915, US

(21) Appl. No.: 10/470,397

(22) PCT Filed: Jan. 28, 2002
(86) PCT No.: PCT/GB02/00346

(30) Foreign Application Priority Data
Jun. 29, 2001 (GB) 0102212.8

(51) Int. Cl. H02M 1/00

(52) U.S. Cl. 363/1

(57) ABSTRACT

A method and apparatus are disclosed for disconnecting an electrical generator from the domestic single phase electricity supply if one or more of a number of monitored parameters of the domestic electricity supply goes out of a predetermined ragne. The parameters of the domestic electricity supply that are monitored are voltage, frequency and rate of change of frequency.

The present invention relates to a controller for disconnecting an electrical generator from the domestic electricity supply if one or more of a number of monitored parameters of the domestic electricity supply goes out of a predetermined range.

Electrical generators are increasingly being used in domestic situations to supply some or all of the total household electrical load or even to supply some excess electricity to the grid. The electrical generator needs to be connected to the domestic energy supply which will still supply electricity at least for peak periods. However, if the domestic electricity supply provides electricity which is outside normal specifications the domestic electrical generator may be damaged or function inefficiently.

According to a first aspect of the present invention there is provided a controller for disconnecting an electrical generator from the single phase domestic electricity supply, the controller comprising

means for determining whether the frequency of the single phase domestic electricity supply falls outside a predetermined range;

means for determining whether the rate of change of frequency of the single phase domestic electricity supply falls outside a predetermined range;

means for determining whether the voltage of the single phase domestic electricity supply falls outside a predetermined range and

means for disconnecting an electrical generator from the single phase domestic electricity supply if any of the determining means determines that its measured parameter is outside its particular predetermined range.

By disconnecting the electrical generator from the single phase domestic electricity supply if any of the monitored parameters falls outside its predetermined range, the electrical generator is protected from being damaged or being operated outside its most efficient operating range.

The means for disconnecting an electrical generator from the single phase domestic electricity supply preferably comprises a logic circuit to produce an output to actuate a disconnecting means to disconnect the electrical generator if any of the determining means detects that a measured parameter is outside its particular predetermined range. The disconnecting means may be a relay, a contactor or a more elaborate disconnection/connection device.

The controller is preferably provided as a single integrated block with the determining means and disconnecting means provided as a unit. The determining means and disconnecting means may be provided by discrete electronic components or implemented using a computing means.

According to a second aspect of the present invention there is provided a method for disconnecting an electrical generator from the single phase domestic electricity supply, the method comprising

determining whether the frequency of the single phase domestic electricity supply falls outside a predetermined range;

determining whether the rate of change of frequency of the single phase domestic electricity supply falls outside a predetermined range;

determining whether the voltage of the single phase domestic electricity supply falls outside a predetermined range and

disconnecting an electrical generator from the single phase domestic electricity supply if any of the measured parameters is outside its particular predetermined range.

The electrical generator is preferably disconnected from the single phase domestic electricity supply using a logic circuit to activate a disconnecting means.

An example of a controller illustrating the present invention will now be described with reference to the accompanying drawings in which:

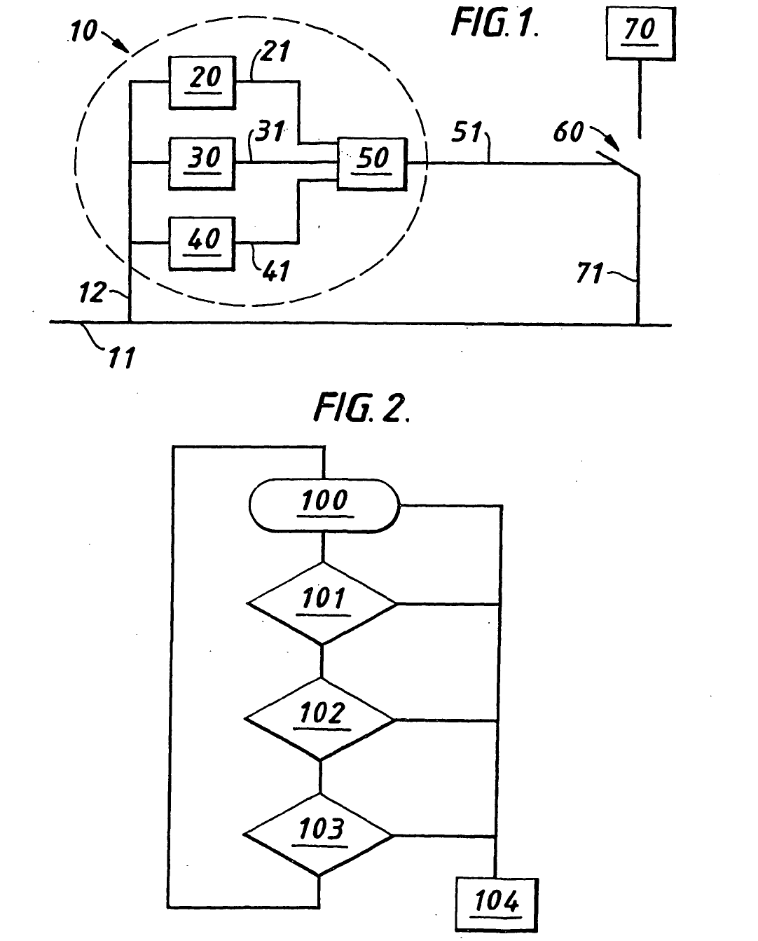

FIG. 1 schematically shows a controller according to the first aspect of the present invention;

FIG. 2 is a flow diagram showing the method according to the second aspect of the present invention and

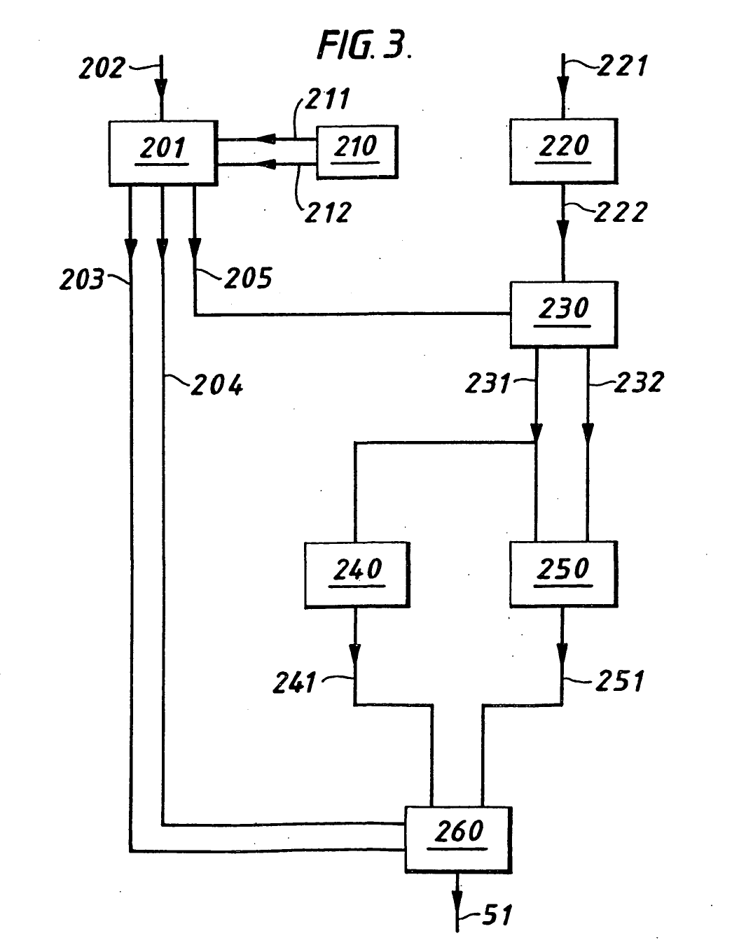

FIG. 3 shows the structure of the controller in more detail.

The controller 10 of FIG. 1 is connected to the single phase domestic electricity supply 11 via line 12. Line 12 is connected to frequency determining means 20, rate of change of frequency determining means 30 and voltage determining means 40 all provided within controller 10. The determining means 20, 30, 40 monitor the alternating current single phase electricity provided on supply line 11.

When the frequency determining means 20 determines that the frequency of the single phase electricity supply 11 is outside a predetermined range it sends a signal on line 21 to a logic circuit 50. In the present example the acceptable predetermined frequency range is + or −1% of the standard single phase electricity supply frequency 11 which in the UK is 50 Hz. However, other suitable frequency ranges could be used such as between +1% and −6% of any desired frequency.

When the rate of change of frequency determining means 30 determines that the rate of change of frequency of the single phase electricity supply 11 is outside its predetermined range it sends a signal on line 31 to logic circuit 50. In the present example the acceptable predetermined rate of change of frequency range is + or −1 Hz per second. However, other suitable ranges could be used such as + or −0.5 Hz per second.

When the voltage determining means 40 determines that the voltage of the single phase electricity supply 11 is outside its predetermined range it sends a signal on line 41 to logic circuit 50. In the present example the acceptable predetermined voltage range is + or −10% of the standard single phase electricity voltage which in the UK is 230 V. However, of course any suitable voltage range may be selected depending on the generator, electricity supply and controller used.

When logic circuit 50 receives a signal on any of lines 21, 31 or 41 indicating that a measured parameter of the single phase domestic electricity supply is outside its predetermined range it sends a signal on line 51 to disconnecting means 60 which in this case is a relay on line 71 connected between an electrical generator 70 and the single phase domestic electricity supply 11.

FIG. 2 schematically shows the steps conducted by the logic circuit 50. The logic sequence starts at step 100. At step 101 the logic circuit determines whether there is a signal on line 21 indicating that the frequency of the single phase domestic electricity supply is outside its predetermined range. If the signal on line 21 indicates that the electricity supply is outside its predetermined frequency range the logic circuit proceeds to step 104 which produces a signal on line 51 to disconnect the generator 70 from the electricity supply 11 using relay 60. If the signal on line 21 indicates that the electricity supply 11 is within its predetermined frequency range the logic circuit proceeds to step 102.

At step 102 the logic circuit determines whether there is a signal on line 31 indicating that the rate of change of frequency of the single phase domestic electricity supply 11 is outside its predetermined range. If the signal on line 31 indicates that the rate of change of frequency of the electricity supply 11 is outside its predetermined range the logic circuit 50 proceeds to step 104 which produces a signal on line 51 to disconnect the generator 70 from the electricity supply 11 using relay 60. If the signal on line 31 indicates that the electricity supply is within its predetermined frequency range the logic circuit proceeds to step 103.

At step 103 the logic circuit determines whether there is a signal on line 41 indicating that the voltage of the single phase domestic electricity supply 11 is outside its predetermined range. If the signal on line 41 indicates that the voltage of the electricity supply 11 is outside its predetermined range the logic circuit 50 proceeds, to step 104 which produces a signal on line 51 to disconnect the generator 70 from the electricity supply 11 using relay 60. If the signal on line 41 indicates that the electricity supply is within its predetermined voltage range the logic circuit proceeds to step 100.

FIG. 3 shows the structure of controller 10 in more detail. Circuit 201 performs supply voltage signal conditioning. This circuit has an input voltage 202 which is proportional to the voltage of the domestic supply and which is buffered, filtered and conditioned. This circuit 201 also receives two voltages 211 and 212 from voltage reference circuit 210. Voltages 211 and 212 are in this example able to be set to the desired maximum and minimum voltages respectively so that the controller may be used in different circumstances. If the supply voltage signal 202 indicates that the supply voltage is greater than that indicated by the maximum supply voltage signal 211 then an “over volts” signal 203 is supplied to the decision logic circuit 260. If the supply voltage signal 202 indicates that the supply voltage is less than that indicated by the minimum supply voltage signal 212 than an “under volts” signal 204 is supplied to decision logic circuit 260. A square wave frequency signal 205 of constant amplitude is also produced and sent to a power factor measurement circuit 230. The frequency of signal 205 corresponds to the frequency of the supply voltage from signal 202. A further signal, which is not shown, corresponding to the supply voltage is also produced and used for monitoring purposes.

Circuit 220 performs supply current signal conditioning. This circuit 220 has an input voltage 221 which is proportional to the load current and which is buffered, filtered and conditioned. This circuit 220 produces a square wave frequency signal 222 of constant amplitude which is sent to power factor measurement circuit 230. The frequency of signal 222 corresponds to the frequency of the supply current from signal 221. Circuit 220 also produces a further output which is not shown corresponding to the supply current and which is used for monitoring purposes.

Power factor measurement circuit 230 receives square wave signals 205 and 222 corresponding to the frequency of the voltage and current of the supply respectively. Power factor measurement circuit 230 produces a buffered version of the square wave supply voltage frequency signal on line 231 to both a rate of change of frequency (ROCOF) circuit 240 and a frequency limits monitoring circuit 250. Power factor measurement circuit 230 also produces a narrow pulse signal 232, with the pulses aligned with the leading edges of the square waves of the supply voltage frequency signal 205. Signal 232 is supplied to the frequency limits monitoring circuit 250. In this example the power factor measurement circuit 230 also produces an analogue voltage not shown which is proportional to the difference between the phase of the square wave signals 205 and 222 corresponding to the frequency of the voltage and current of the supply respectively. This signal is used for monitoring purposes.

ROCOF circuit 240 receives the buffered square wave signal 231 corresponding to the frequency of the supply voltage. ROCOF circuit 240 includes a phase lock loop, which tracks the frequency from signal 231. The phase lock loop has a time constant set by its components and if the input frequency changes suddenly or at a rate above that set then the circuit produces an error signal which is sent to the decision logic circuit 260 via line 241.

Frequency limits monitoring circuit 250 receives the buffered square wave signal 231 corresponding to the frequency of the supply voltage 11 and the pulsed signal 232. This circuit includes a stable high frequency crystal controlled oscillator which supplies a signal to a series of counters which are periodically reset by the pulse input. The counter outputs are monitored by a frequency window comparator, which only produces a valid output on line 251 to logic circuit 260 if the supply voltage frequency signal is within specified parameters.

Decision logic circuit 260 which is combinational logic circuit monitors the following input signals:

203: supply voltage too low

204: supply voltage too high

241: ROCOF output within range

251: supply frequency within range

While these input signals are satisfactory (ie supply voltage not too low, supply voltage not too high, ROCOF output within range and supply frequency within range) the circuit produces an output which connects the electrical generator 70 to the domestic supply 11 via the relay 60.

The circuits shown in FIG. 3 are constructed from electronic components such as operational amplifiers, diodes, resistors, capacitors, logic gates etc and are preferably provided as a single integrated control circuit making it suitable for mass manufacture reducing costs and size.

1. A Controller for disconnecting an electrical generator from the single phase domestic electricity supply, the controller comprising
means for determining whether the frequency of the single phase domestic electricity supply falls outside a predetermined range;
means for determining whether the rate of change of frequency of the single phase domestic electricity supply falls outside a predetermined range;
means for determining whether the voltage of the single phase domestic electricity supply falls outside a predetermined range and
means for disconnecting an electrical generator from the single phase domestic electricity supply if any of the determining means determines that it measure parameter is outside its particular predetermined range.

2. A Controller according to claim 1, wherein the means for disconnecting an electrical generator from the single phase domestic electricity supply comprises a logic circuit to produce an output to activate a disconnecting means.

3. A Controller according to claim 1, wherein the Controller is provided as a single integrated unit.

4. A Controller according to claim 1, wherein the determining means and the disconnecting means are provided by discrete electronic components.

5. A method for disconnecting an electrical generator from the single phase domestic electricity supply, the method comprising
determining whether the frequency of the single phase domestic electricity supply falls outside a predetermined range;
determining whether the rate of change of frequency of the single phase domestic electricity supply falls outside a predetermined range;
determining whether the voltage of the single phase domestic electricity supply falls outside a predetermined range and
disconnecting an electrical generator from the sign phase domestic electricity supply if any of the measured parameters is outside its particular predetermined range.

6. The method according to claim 5, wherein an electrical generator is disconnected from the single phase domestic electricity supply using a logic circuit to activate a disconnecting means.
